(19) United States
(12) Patent Application Publication
(10) Pub. No.: US 2026/0163433 A1
(43) Pub. Date: Jun. 11, 2026

(54) CONNECTION ELEMENT FOR COIL WINDINGS OF STATOR COILS OF AN ELECTRIC MOTOR

(71) Applicant: iwis mobility systems GmbH & Co. KG, München (DE)

(72) Inventors: Ulrich LINDNER, München (DE); Andreas RITZ, München (DE)

(21) Appl. No.: 19/409,623

(22) Filed: Dec. 4, 2025

(30) Foreign Application Priority Data
Dec. 11, 2024 (DE) 102024137109.9

(51) Int. Cl. H02K 3/28; H02K 1/14; H02K 3/18; H02K 15/33

(52) U.S. Cl. CPC H02K 3/28; H02K 1/14; H02K 3/18; H02K 15/33; H02K 2203/09; H02K 2213/03

(57) ABSTRACT

A connection element for the wire ends of stator coils of an electric motor is provided, wherein at least one stator coil includes at least two wire windings and the connection element is a fork-shaped contact element with two clamping legs which together form a wire receptacle for the wire ends of the at least two wire windings and a separate insertion opening. The wire receptacle of the connection element between the two clamping legs of the fork-shaped contact element is essentially conical in shape and has a base section, a conical clamping section that widens in the direction of the insertion opening, and an opening section, wherein the conical clamping section between the two clamping legs including an angle between 10° and 20°. Furthermore, a connector ring for a multiphase electric motor with several stator coils and such a multiphase electric motor, as well as a method for contacting the wire ends of a stator coil are provided.

### CROSS-REFERENCE TO RELATED APPLICATION

This application claims priority to foreign German patent application No. DE 102024137109.9, filed on December 11, 2024, the disclosure of which is incorporated by reference in its entirety.

### FIELD OF THE INVENTION

The present invention relates to a connection element for the wire ends of stator coils of an electric motor, wherein at least one stator coil comprises at least two wire windings and the connection element is a fork-shaped contact element with two clamping legs which together form a wire receptacle for the wire ends of the at least two wire windings and a separate insertion opening. Furthermore, the invention relates to a connector ring for a multiphase electric motor with several stator coils and such a multiphase electric motor, as well as a method for contacting the wire ends of a stator coil.

### BACKGROUND

Electric motors comprise a rotor connected to a motor shaft and mounted in a housing so that it can rotate, as well as a stator with several stator coils. When the stator coils are controlled appropriately using a phase controller, the coil windings of the coils generate a magnetic field that drives the rotor to rotate. In conventional electric motors, the wire coil windings of the stator coils are wound in three phases and are connected to the phase controller via three electrical connections. For this purpose, the wire ends of the wire coil windings are usually manually welded or soldered to the connections of the phase controller. To improve the synchronous behavior per phase, modern electric motors are equipped with several stator coils and, for redundancy reasons, may also comprise several wire windings in each stator coil, which increases the number of electrical connections. Multiphase electric motors therefore use connector rings with multiple phase conductor tracks for electrical contact, which are connected to the coil windings via multiple connection tabs and to the phase controller via corresponding contact elements. Here, too, the wire ends of the coil windings are often connected to the connection tabs by means of welded or soldered joints. Alternatively, it is also known to connect the wire ends by means of insulation displacement contacts (IDC). The publication EP 2212985B1 describes, for example, a multiphase brushless electric motor in which the coil windings of the stator coils of one phase are connected by means of a connector ring. This electric motor comprises a housing in which a rotor is rotatably mounted and a stator provided with several stator coils is arranged. The stator is connected to the phase control via a connector ring, wherein several phase conductor tracks supply current to the coil windings of the stator coils of one phase. The phase conductor tracks comprise several connection elements designed as cutting-clamping contacts for the wire ends of the stator coils, as well as connection tabs for contacting the phase controller. The entire electric motor, including the commutator ring, is overmolded so that only the connection tabs protrude from the housing to the outside.

### SUMMARY OF THE INVENTION

The present invention is therefore based on the task of providing safe and reliable contacting of the coil windings of several stator coils, in particular for a multiphase electric motor.

According to the invention, this task is solved by a connection element for contacting wire ends according to claim 1. The wire receptacle of the connection element for the wire ends of the at least two wire windings between the two clamping legs of the fork-shaped contact element is essentially conical in shape. The conically shaped wire receptacle comprises a base section, a conical clamping section, and an opening section, wherein the conical clamping section widens from the base section in the direction of the insertion opening or the opening section and forms an angle between 5° and 30°, in particular between 10° and 20°, preferably approximately 14°, corresponding to 14° +/- 10%. Furthermore, the conical clamping section can extend over at least 40%, preferably over at least 60% of the length of the entire conically shaped wire receptacle, wherein the conical clamping section is formed by the straight inner sides of the clamping legs. The opening section adjoining the conical clamping section tapers towards the insertion opening of the wire receptacle. The essentially conical wire receptacle for the wire ends of the at least two coil windings of a stator coil enables a two-phase crimping process in which the wire ends of the at least two coil windings are first secured in the wire receptacle and then fixed therein in order to achieve a fixed positioning for a downstream soldering or welding process for connecting the wire ends to the fork-shaped contact element. Crimping first fixes the wire ends in the conically shaped wire receptacle so that any protruding wire sections or a winding spacer can then be removed from the connection element before the wire ends can be permanently connected, preferably welded, to the clamping legs.

The special shape of the conical wire receptacle enables secure and reliable contact between the wire ends of at least two coil windings, regardless of the position of the wire ends in the wire receptacle, i.e., whether the at least two wire ends touch each other in the wire receptacle or are spaced apart. After inserting the wire ends through the separate insertion opening of the fork-shaped contact element, one wire end is usually positioned at the base section of the wire receptacle and another wire end is positioned at the opening section of the conically shaped wire receptacle or somewhere between the wire end positioned at the base section and the opening section. When the two clamping legs are pressed together, the at least two wire ends can first be secured in the wire receptacle and then fixed therein, wherein the clamping force of the bent and plastically deformed clamping legs is relatively uniform on all wire ends, or at least sufficient to securely fix all wire ends in the wire receptacle between the two clamping legs.

A practical embodiment provides that the length of the conically shaped wire receptacle in the longitudinal direction of the contact element between the base section and the opening section is between 1.2 times and 2.0 times, preferably between 1.25 times and 1.5 times, the sum of the diameters of the wire ends. The longitudinal direction of the fork-shaped contact element or the two clamping legs also corresponds to the insertion or introduction direction of the wire ends of the at least two wire windings when mounting the connection element, wherein the wire ends are defined as the wire sections protruding from a stator of an electric motor, which may still be connected to a holding device, for example a winding glasses, before the wire ends are fixed with the connection element, and which emerge from the stator coil parallel to each other or close to each other. The greater length of the conically shaped wire receptacle in the longitudinal direction of the contact element compared to the sum of the diameters of all wire ends accommodated in the wire receptacle allows the wire ends to be easily accommodated in the conically shaped wire receptacle during the assembly of an electric motor, even if the wire ends are in different positions on the wound stator coil.

This allows for greater tolerances when winding the at least two coil windings of a stator and positioning the emerging wire ends.

A further design provides that the base section between a curved base at the lower end of the wire receptacle and the conical clamping section comprises a conical base area which forms an angle of between 60° and 70°, preferably approximately 65° +/- 1°, between the straight lines of the inner sides of the two clamping legs. This allows the lower wire end of at least two wire coil windings to rest well in the base section, wherein the conical base area or the straight lines of the inner sides are in contact with the lower wire end only below the center of the wire. During the crimping process, the lower wire end can move upward toward the conical clamping section at the conical base area and form a bending point for the two clamping legs at the transition between the conical base area and the conical clamping section.

Advantageously, the insertion opening between the two clamping legs of the fork-shaped contact element may comprise lead-in chamfers at the free ends of the two clamping legs, wherein the angles of the lead-in chamfers relative to the longitudinal direction of the contact element are each between 20° and 45°, preferably between 25° and 35°, in particular, approximately 30° +/- 1°. The lead-in chamfers, which open outwards, allow the wire ends of the at least two coil windings to be easily inserted during the assembly of the electric motor, even if the positions of the wire ends deviate radially.

A preferred variant provides for the insertion opening to comprise an insertion slot which extends between the lead-in chamfers of the two clamping legs and the opening section of the conically shaped wire receptacle and is formed by two substantially parallel sections of the inner sides of the two clamping legs, wherein the distance between the substantially parallel sections of the inner sides of the two clamping legs is at least equal to the diameter of the wire ends, preferably 1.05 times the diameter of the wire ends. This allows the wire ends of the at least two wire windings to be fed relatively smoothly through the insertion slot of the insertion opening during assembly of the electric motor and, at the same time, the wire ends to be securely held in the subsequent conically shaped wire receptacle.

The present invention further relates to a connector ring for a multiphase electric motor with several stator coils, in particular with at least two stator coils per phase, wherein at least one stator coil comprises at least two wire windings, as well as with at least one phase conductor track, a connection tab for contacting a phase controller of the stator coils, and at least one of the connection elements described above for the wire ends of stator coils. Such a connector ring enables safe and reliable contacting of the coil windings of multiple stator coils, particularly in the automated manufacture of multiphase electric motors.

In a practical design, several phase conductor tracks can be provided for such a connector ring, wherein the phase conductor tracks are formed as circular ring sections and are arranged offset from one another in order to contact the stator coils of the multiphase electric motor arranged next to one another by means of the connection elements. This enables both a simple design of a switching ring and simple and fast contacting of a large number of stator coils.

A special embodiment provides that each phase conductor track is manufactured as a stamped and bent component with the connection tab for contacting a phase controller and the connection elements described above for the wire ends of stator coils. This allows phase conductor tracks and complete switching rings to be manufactured cost-effectively, enabling reliable contacting of the phase controller with the coil windings of the stator coils of multiphase electric motors.

Furthermore, the present invention also relates to a multiphase electric motor with a rotor, a stator, and several stator coils, wherein at least one stator coil comprises at least two wire windings, as well as with one of the switching rings described above, wherein the wire ends of the at least two wire windings are crimped and additionally welded in a connection element of the switching ring. Such a multiphase electric motor comprises secure and reliable contacting of the wire windings, since the essentially conical wire receptacle between the two clamping legs in the fork-shaped contact element applies sufficient clamping force to the wire ends of the at least two wire windings of stator after a crimping process in order to subsequently remove a retaining device or winding spacer and securely weld the wire ends to the two clamping legs of the fork-shaped contact element. coils to remove a holding device or winding glasses downstream and to securely weld the wire ends to the two clamping legs of the fork-shaped contact element.

The present invention also relates to a method for contacting the wire ends of a stator coil with at least two wire windings by means of one of the connection elements described above, with the at least two wire ends of the stator coil being inserted through the insertion opening into the essentially conical wire receptacle between the two clamping legs of the fork-shaped contact element, wherein one wire end is arranged at a base section of the conically shaped wire receptacle, with the two clamping legs being pressed together by means of two inclined clamping jaws which bear against the outer sides of the two clamping legs, bending the two clamping legs over the wire end arranged at the base section, whereby the opening of the essentially conical wire receptacle tapers and secures the other wire ends of the coil in the wire receptacle against falling out, further pressing together the two clamping legs by means of the two inclined clamping jaws, and by plastically deforming the two clamping legs in the area of the wire end arranged on the base section, whereby the opening of the essentially conical wire receptacle further tapers and, in particular, aligns essentially parallel in order to fix the other wire ends of the coil in the wire receptacle. The at least two wire ends can either touch each other or be arranged at a distance from each other in the conically shaped wire receptacle. Thus, the at least two wire ends can be arranged lying on top of each other on the base section, or one wire end can be arranged on the base section and another wire end on the opening section of the conically shaped wire receptacle, but the other wire end can also be arranged at all intermediate positions. When the two clamping legs are pressed together, the wire end arranged at the base section can initially slide along the conical base area due to the steep cone angle, and only at the transition to the conical clamping section with a flatter cone angle can it build up sufficient friction with the inner sides of the two clamping legs to form a bending bearing for the two clamping legs and enable the two clamping legs to bend around the lower wire end. After plastic deformation of the two clamping legs in the area of the wire end arranged at the base section, the other wire ends of the coil are also securely crimped in the wire receptacle and fixed against unintentional slipping out. The plastic deformation allows the respective contact force of the clamping legs on the at least two wire ends in the wire receptacle to be significantly equalized. This process not only allows cost-effective production of electric motors, but also enables reliable automation of the manufacturing process with low reject rates.

A modification of the contacting method provides that the inclined clamping jaws are inclined both relative to the force vector when the clamping legs are pressed together and relative to the outer sides of the associated clamping legs, and the angle of inclination of the clamping jaws relative to the outer sides of the associated clamping legs is between 3° and 7°, preferably approximately 5° +/- 1°, wherein the clamping jaws initially rest against the free ends of the two clamping legs when the two clamping legs are pressed together. This ensures that, at the start of the pressing and bending process, the clamping jaws are positioned at the tips of the clamping legs, enabling the two clamping legs to bend the lower wire end smoothly and evenly.

In order to clamp the wire ends of the at least two wire windings as evenly as possible in the wire receptacle of the connection element, the angle of inclination of the clamping jaws may be smaller than the angle of the inner sides of the clamping legs in the area of the conical clamping section, in particular between 1° and 5° smaller, preferably about 2° +/- 0.5° smaller. Accordingly, after the clamping legs have been pressed together and bent, the inner inclination of the conically shaped clamping section relative to the longitudinal axis in the longitudinal direction of the contact element is approximately 2°. This enables the two clamping legs to be securely plastically deformed around the lower wire end located at the base section, whereby the opening of the previously conically shaped wire receptacle is further tapered following the bending, so that the inner sides of the two clamping legs are ultimately aligned essentially parallel to each other. This allows the clamping forces applied by the two clamping legs to the wire ends of the at least two wire windings to be adjusted to each other so that all wire ends are fixed or crimped relatively evenly in the wire receptacle. The plastic deformation of the two clamping legs in the area of the lower wire end, or at the transition between the conical base area and the conical clamping section, is much greater than in the area of an upper wire end. However, the different angles of inclination of the clamping jaws and the inner sides of the clamping legs also allow sufficient deformation at the upper wire end to fix the wire end in the conically shaped wire receptacle.

Furthermore, the method for contacting the wire ends of a stator coil following the plastic deformation of the two clamping legs for fixing the at least two wire ends of the stator coil between the two clamping legs may comprise removing protruding wire sections from the wire ends fixed in the wire receptacle, in particular removing a winding spacer, providing a welding device, applying the welding device to the connection element, and welding the wire ends of the at least two wire windings to the two clamping legs of the connection element comprise. When winding a stator coil for an electric motor, in particular a plurality of stator coils for a multiphase electric motor, a preload is necessary on the wires for a tight and compact coil winding during the winding process, so that the stator coils often comprise a winding frames after the winding process, which both hinders access to the wire ends in the connection elements and must be removed before the electric motor can be used. Before removing such winding frames, the wire ends must be securely fixed in the connection elements so that the wire coil windings do not come loose and the correct wire ends are assigned to the respective connection elements and electrically connected to them. Welding the wire ends of at least two coil windings to the two clamping legs finally establishes a secure electrical contact between the coil windings and the connection element, wherein the welding simultaneously enables a low-resistance electrical contact and a high current load rating of the contact.

A special design provides for the welding device to be configured as welding tongs, in particular as a cooled welding tong, wherein the welding tongs are pressed against the fork-shaped clamping element of the connection element and the wire ends of the stator coil fixed between the two clamping legs are welded to the two clamping legs in order to enable secure electrical contact between the wire ends of the at least two coil windings and the connection element. A welding device designed as a welding clamp, which is pressed onto the fork-shaped clamping element of the connection element from the outside, enables the safe and cost-effective automated production of stator coils for electric motors with low-resistance contacts and high current carrying capacity. however, such welding tongs, in particular cooled welding tongs, are relatively large devices and require free access to the fork-shaped clamping element of the connection element.

### BRIEF DESCRIPTION OF THE DRAWINGS

A non-limiting embodiment of the present invention is explained in more detail below with reference to exemplary drawings.

FIG. 1 a perspective view of an electric motor according to the invention,

FIG. 2 a perspective view of the electric motor from FIG. 1 without housing,

FIG. 3 a perspective view of a connector ring according to the invention for the electric motor from FIG. 1,

FIG. 4 a sectional view of the phase conductor tracks and the stator coils of the electric motor from FIG. 1,

FIG. 5 a detailed view of the connection element according to the invention from FIG. 2,

FIG. 6A a side view of the connection element and the clamping jaws,

FIG. 6B a side view of the connection element with the clamping jaws in contact,

FIG. 6C a side view of the connection element during compression and bending of the clamping legs,

FIG. 6D a side view of the connection element during compression and deformation of the clamping legs.

### DETAILED DESCRIPTION

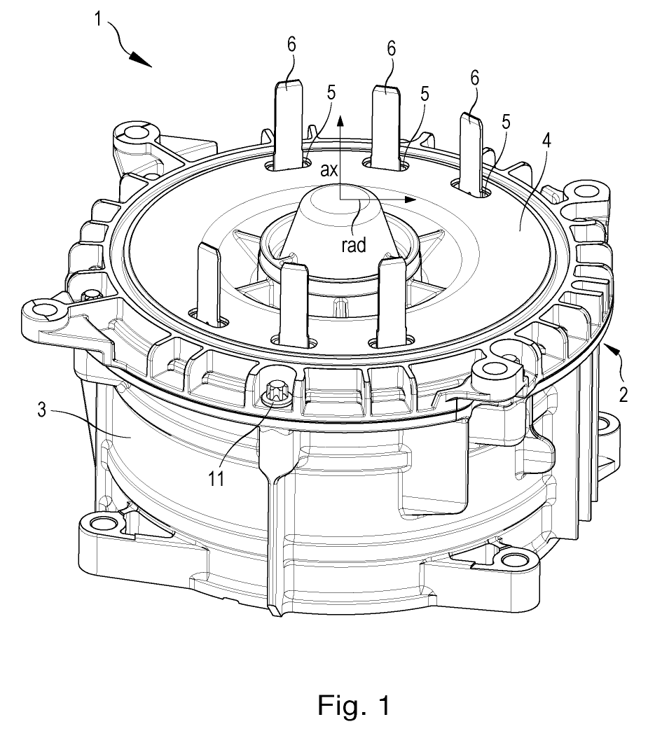

The electric motor 1 according to the invention shown in FIG. 1 comprises a housing 2 with a housing body 3 and an upper bearing shield 4, wherein the housing body 3 is essentially cup-shaped and open at the top. On the open side of the housing body 3, the bearing shield 4 is screwed to the housing body 3 by means of screws 11. Six connection feed-throughs 5 are formed in the bearing shield 4. Six electrical connections of the electric motor 1, designed as connection tabs 6, emerge from the electric motor 1 at the connection feed-throughs 5. The connection feed-throughs 5 seal the interior of the housing 2 against fluids from the outside. The connection tabs 6 are connected to a phase controller arranged outside the housing 6 and serve to supply power and control the stator coils 12 of the electric motor 1. The axial direction ax of the electric motor 1 extends in the direction of the axis of the motor shaft 8, while the radial direction rad is oriented perpendicular thereto.

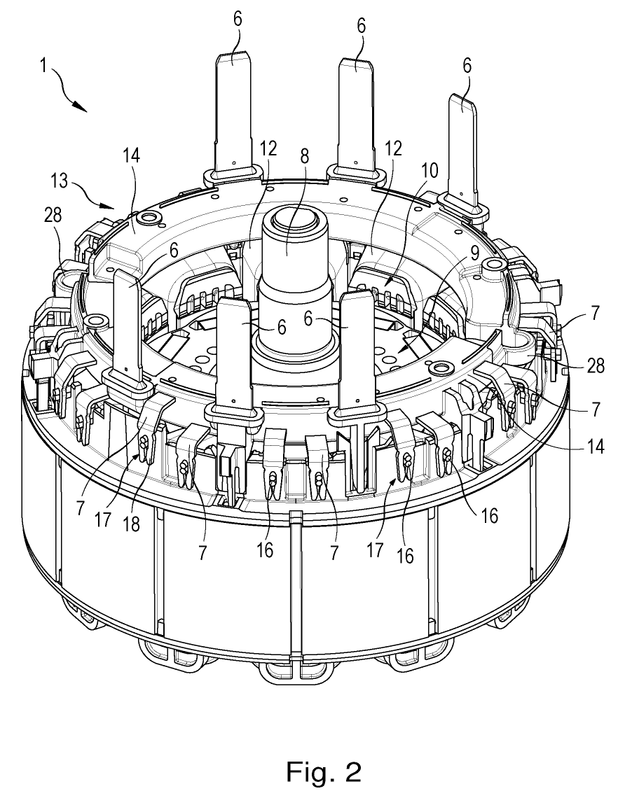

FIG. 2 shows the electric motor 1 according to the invention from FIG. 1 without the housing body 3 and the bearing shield 4. The electric motor 1 shown without the housing 2 comprises a rotatably mounted rotor 9 with the motor shaft 8 and a stator 10. The stator 10 comprises a plurality of stator coils 12. A connector ring 13 is attached to the stator 10, which serves to contact the stator coils 12. The connector ring 13 has a redundant structure with two sub-segments 14 and a total of six connection tabs 6 for contacting the phase controller. Two connection tabs 6 are always assigned to one phase of the three-phase electric motor 1. This makes it possible to control only half of the stator coils 12 of the stator 10 during emergency operation of the electric motor 1.

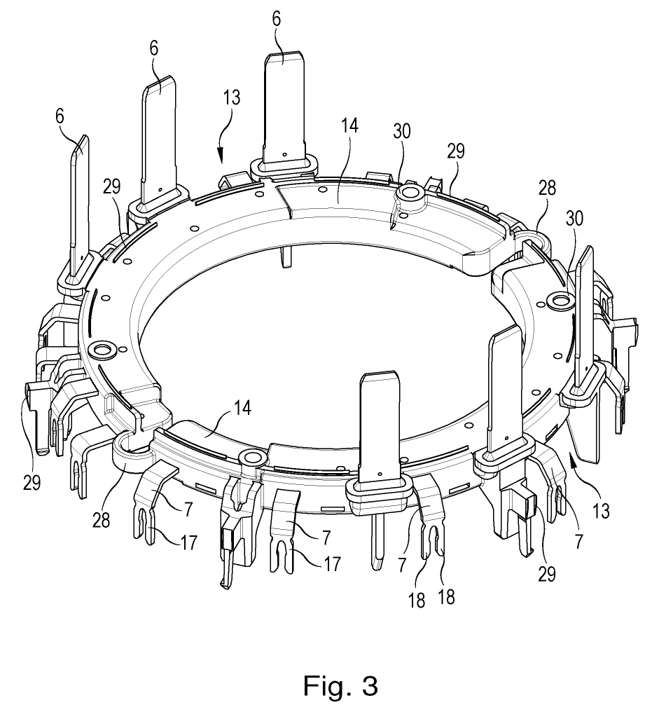

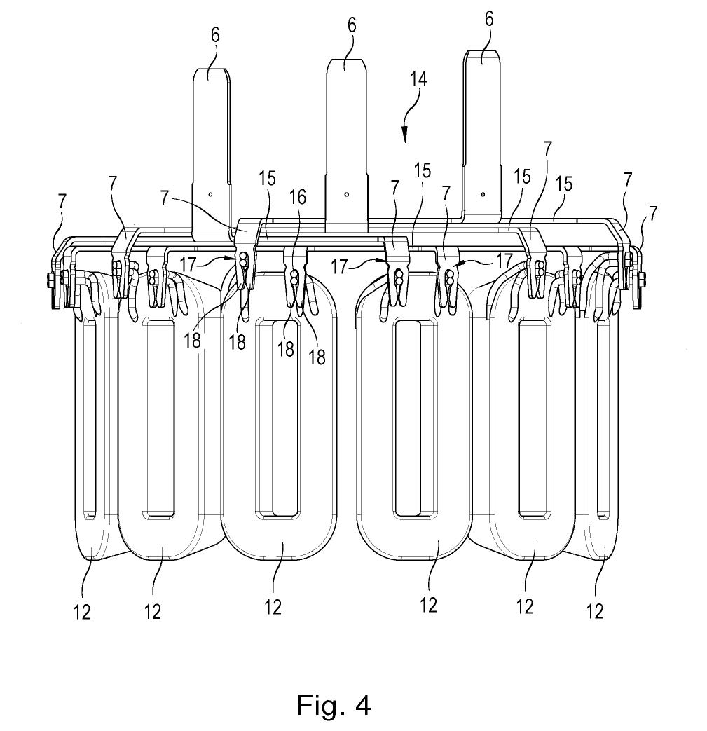

The electric motor 1 comprises a total of twelve stator coils 12, wherein six stator coils 12 are each assigned to a sub-segment 14 of the connector ring 13, see also FIG. 4. In this case, two stator coils 12 are assigned to the sub-segment 14 of a phase, so that the six stator coils 12 of a sub-segment 14 form a three-phase half motor, so to speak. The two stator coils 12 assigned to one phase are each connected by means of a phase conductor track 15, wherein only the assigned connection tabs 6 and the connection elements 7 for electrical contacting of the stator coils 12 are visible in FIGS. 2 and FIG. 3.

The switching ring 13 is placed on the stator 10, wherein the connection elements 7 of the phase conductor tracks 15 protruding laterally from the switching ring 13 initially only accommodate the wire ends 16 of the stator coils 10. The connection elements 7 comprise downwardly open fork-shaped contact elements 17, wherein the opening extends in the longitudinal direction between the clamping legs 18, in particular parallel to the axial direction ax of the motor shaft 8. This ensures that the connector ring 13 is pluggable onto the stator 10 in the axial direction ax and that the wire ends 16 can be easily accommodated in a wire receptacle 20 of the fork-shaped contact elements 17. In a further assembly step, the two clamping legs 18 can then be crimped (not shown here) and welded to enable secure electrical contact between the wire ends 16 and the connection element 7.

FIG. 3 shows a detailed view of the connector ring 13 according to the invention from FIG. 2. The two arcuate sub-segments 14 of the connector ring 13, which are connected to each other by two elastic connecting elements 28, are clearly visible. Of the phase conductor tracks 15, which are overmolded with plastic, only the connection tabs 6 and the connection elements 7 are visible here. The base sections of the phase conductor tracks 15, which run parallel to each other, are completely overmolded with plastic and are therefore not visible in FIG. 3. The arcuate base sections of the phase conductor tracks 15 arranged one above the other without plastic embedding, which run at a distance from each other, are clearly visible in the cutaway view of the connector ring 13 and the stator coil 12 shown in FIG. 4. The connection tabs 6 of the phase conductor tracks 15 protrude radially rad from the base sections and extend further in the axial direction ax upwards. The connection elements 7 of the phase conductor tracks 15 also initially protrude radially rad outwards beyond the respective base section and then extend further in the axial direction ax downwards. The fork-shaped contact elements 17, each with two clamping legs 18 and an opening between the clamping legs 18, are also clearly visible. Distributed around the circumference of the connector ring 13, both on the upper side and in the radial direction, which engage with the housing 2 when the electric motor 1 is assembled, as well as several protrusions 30 to firmly connect the connector ring 13 to the housing body 3 and the bearing shield 4 and to reduce vibrations.

FIG. 4 shows a lateral view of the phase conductor tracks 15 and the stator coils 12 of the electric motor 1, wherein only a sub-segment 14 of the connector ring 13 and the associated stator coils 12 are shown. The axial offset of the arcuate base sections of the phase conductor tracks 15 relative to each other is clearly visible. The upper three phase conductor tracks 15 are designed as identical parts, wherein the connection tabs 6 extend upward in the axial direction ax and the connection elements 7 extend downward in the axial direction ax. The resulting axial offset of the connection elements 7 relative to the stator coils 12 is compensated for in the present embodiment by a corresponding offset of the wire ends 16 of the stator coils 12 in the axial direction ax. The downwardly protruding fork-shaped contact elements 17 grip the wire ends 16 of the stator coils 12 with their clamping legs 18. The lowest phase conductor track 15 connects all six stator coils 12 to each other as a neutral point conductor track.

To illustrate the assignment of the phase conductor tracks 15 to the stator coils 12, only the stator coils 12 of one half of the motor are shown in FIG. 4. Thus, the uppermost phase conductor track 15 connects the third and sixth stator coils 12 with the connection elements 7, viewed from the left, whereby these stator coils 12 form a first phase. Similarly, the second phase conductor track 15 connects the second and fifth stator coils 12 from the left with its connection elements 7, forming a second phase. Furthermore, the third phase conductor track 15 connects the first and fourth stator coils 12 from the left with its connection elements 7 from above, whereby these stator coils 12 form a third phase. To implement a star connection, the lowest phase conductor tracks 15 with their six connection elements 7 connect all six stator coils 12 to each other. Here too, as already shown in FIG. 2, the fork-shaped contact elements 17 of the connection elements 7 are only shown in a plugged-in, uncrimped state.

FIGS. 3 and 4 clearly illustrate that a sub-segment 14 of the connector ring 13 with the associated stator coils 12 forms a three-phase half motor, wherein the two sub-segments 14 are identically constructed. The two half motors can be combined into one electric motor 1 by means of appropriate control using the phase controller. The advantage of using two three-phase half motors is that the electric motor 1 can also run with only one half motor, at least in emergency mode. The use of a connector ring 13 with two sub-segments 14 not only enables a redundant design but also increases the operational reliability of the electric motor 1.

The phase conductor tracks 15 provided here with connection elements 7 designed as fork-shaped contact elements 17 allow the connector ring 13 to be easily attached in the axial direction ax to the stator 10 and its stator coils 12. The opening between the two clamping legs 18 of the fork-shaped contact elements 17 is designed so that the wire ends 16 of the at least two wire coil windings of the stator coils 12 can be easily accommodated in a wire receptacle 20 between the two clamping legs 18 of the fork-shaped contact element 17 when pushed on via a separate insertion opening 19 between the two clamping legs 18. The wire ends 16 are then crimped in the common wire receptacle 20 by pressing the two clamping legs 18 together and, optionally, welded to the two clamping legs 18.

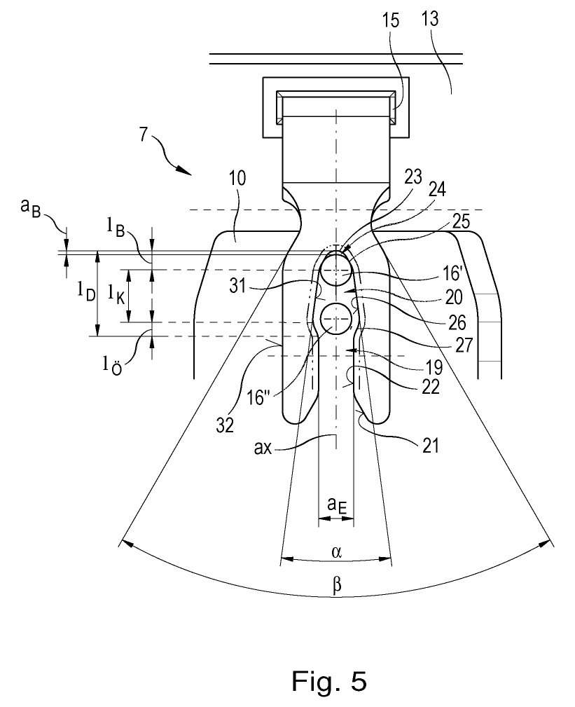

FIG. 5 shows a detailed view of FIG. 2 showing the connection element 7. The connection element 7 extends first in the radial direction rad from the base section of the phase conductor tracks 15 embedded in the connector ring 13 and then in the axial direction ax downwards to the stator coil 12 and the radially protruding wire ends 16 of the at least two wire coils of the stator coil 12. FIG. 5 clearly shows the fork-shaped contact element 17 at the plug end of the connection element 7 with the two clamping legs 18 extending in the axial direction ax. The two clamping legs 18 extending in the axial direction ax together form the separate insertion opening 19 and the wire receptacle 20 for at least two wire ends 16.

The separate insertion opening 19 comprises an insertion bevel 21 on the inner sides of the ends of the two clamping legs 18, which are inclined outwards by approximately 30° relative to the axial direction ax with respect to the contact element 17 extending in the axial direction ax. The inner sides 31 of the two contact legs 18 extend from the lead-in chamfers 21 parallel to each other to the wire receptacle 20 and form an insertion slot 22, wherein the distance a_{E} between the parallel inner sides 31 in the insertion slot 22 corresponds approximately to the diameter of the wire ends 16, in particular slightly greater than the diameter of the wire ends 16. The wire receptacle 20 is essentially conical in shape and extends between a base 23 of the wire receptacle 20 and the insertion slot 22, wherein the essentially conical wire receptacle 20 comprises a base section 24 with a conical base area 25, a conical clamping section 26, and a tapered opening section 27. Two wire ends 16 are arranged in the wire receptacle 20, wherein the lower wire end 16' rests against the conical base area 25 of the base section 24 and the upper wire end 16" is positioned between the lower wire end 16' and the opening section 27. The designation of lower wire end 16' and upper wire end 16" also refers to the position of the wire ends 16 in the wire receptacle 20 and not to their representation in the figures. Furthermore, the upper wire end 16" may rest against the lower wire end 16' or be positioned at the tapered opening section 27, or be in an intermediate position thereto.

The inner sides 31 of the two clamping legs 18 in the base area 25 run as straight lines inclined outward, so that the opening angle β of the conical base area 25 is approximately 65°. The lower wire end 16' merely rests on the conical base area 25 of the base section 24 and comprises a distance a_{B} from the lowest point of the curved arc 23, which can be approximately 10 to 15% of the diameter of the wire end. The conical base area 25 is followed by the conical clamping section 26, in which the inner sides 31 of the two clamping legs 18 again run as outwardly inclined straight lines and form the conically opening clamping angle α. The conically opening clamping angle α is approximately 14°, so that the inner sides 31 are inclined outwards by approximately 7° relative to the axial direction ax. The conical clamping section 26 is followed by the opening section 27, in which the distance between the inner sides 31 of the two clamping legs 18 is reduced to the distance a_{E} of the insertion slot 22. While the length l_{B} of the base area 25 and the length l_{Ö} of the opening section 27 are relatively small in relation to the total length l_{D} of the wire receptacle 20, the length l_{K} of the conical clamping section 26 is between 50% and 75% of the total length l_{D} of the wire receptacle 20.

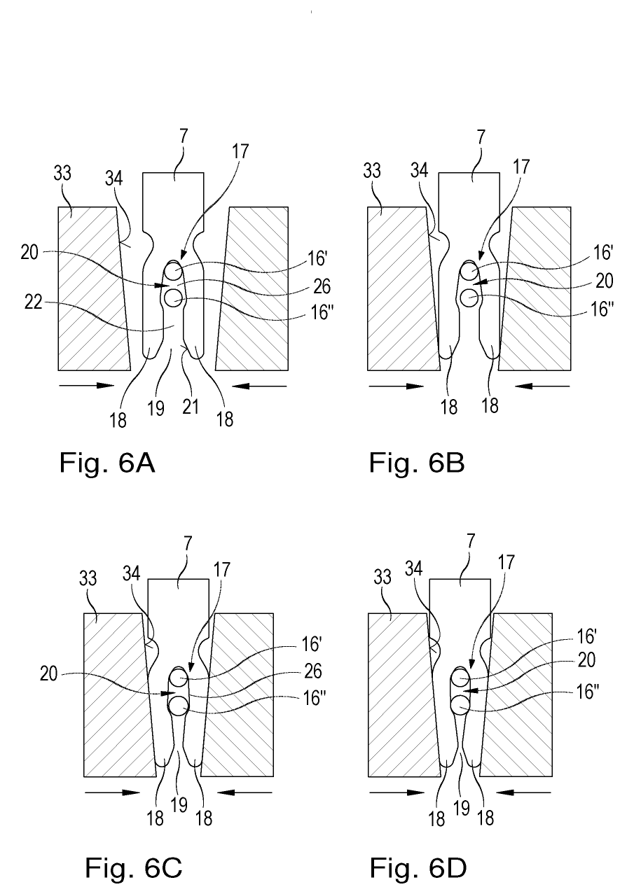

FIGS. 6A to 6D show various steps in the process of contacting the wire ends 16 of the two coil windings of the stator coil 12 with the two clamping legs 18 of the connection element 7. In FIG. 6A, corresponding to FIG. 5, the connection element 7 can be seen with the two clamping legs 18 of the fork-shaped contact element 17 and the two wire ends 16 arranged in the essentially conical wire receptacle 20, as well as two clamping jaws 33 of a crimping device. At the start of the contacting process, the two clamping jaws 33 are moved laterally toward the outer sides 32 of the clamping legs 18, as shown by the arrows in FIG. 6A. The clamping surfaces 34 of the two clamping jaws 33 are inclined relative to the outer sides 32 of the clamping legs 18, so that when the two clamping legs 18 are pressed together, the clamping jaws 33 initially only touch the tips of the clamping legs 18, see also FIG. 6B.

When the two clamping jaws 33 are pressed further together, the wire end 16' initially slides along the conical base area 25 toward the conical clamping section 26. Between the relatively steep opening angle β of the conical base area 25 and the lower wire end 16', only slight friction occurs when the two clamping legs 18 are pressed together, so that the lower wire end 16' initially slides along the conical base area 25. Only at the beginning of the conical clamping section 26, which has a significantly flatter clamping angle α, is the friction between the inner sides 31 of the two clamping legs 18 and the lower wire end 16' sufficiently high so that our wire end 16' is held in its position relative to the two clamping legs 18 and can serve as a bending bearing when the two clamping legs 18 are pressed together. The center axis of our wire end 16' is preferably located directly at the intersection between the conical base area 25 and the conical clamping section 26 or slightly below it, so that during each crimping operation, the bending bearing for the two clamping legs 18 of the connection element 7 is positioned approximately in the same position in the fork-shaped contact element 17 and enables comparable bending and plastic deformation of the two clamping legs 18 in each case. Due to the initial sliding of the lower wire end 16' along the conical base area 25, the distance between the lower wire end 16' and the base 23 of the base section 24 increases slightly during the compression of the two clamping legs 18.

The pressing force of the two clamping jaws 33 in the direction of the arrows shown in FIGS. 6A to 6D initially compresses the two clamping legs 18, wherein the clamping legs 18 are bent around the lower wire end 16' acting as a bending bearing, so that the outer sides 32 of the clamping legs 18 are inclined in the axial direction ax at the end of the compression in accordance with the inclination of the clamping surfaces 34, see FIG. 6C. Pressing the clamping legs 18 together also causes the inner sides 31 in the area of the insertion opening 19 and the wire receptacle 20 to move closer together. In doing so, the clamping legs 18 are not only bent around the lower wire end 16', but also bend slightly themselves, so that the inner sides of the clamping legs 18 can also bend slightly convexly when compressed. In the area of the insertion slot 22, the distance a_{E} between the inner sides 31 is reduced so that the upper wire end 16" no longer fits through the insertion opening 19 and is thus secured in the wire receptacle 20. The inner sides 31 of the clamping legs 18 are also closer together in the area of the wire receptacle 20, wherein the conical clamping section 26 continues to widen slightly in the direction of the insertion opening 19. While the lower wire end 16', which acts as a bending bearing, is fixed by the clamping section 26, the upper wire end 16" is only secured against falling out at the end of the compression of the clamping legs 18 shown in FIG. 6C in the wire receptacle 20.

The slightly conical, outwardly open shape of the conical clamping section 26 after the two clamping jaws 33 have been pressed together and the two clamping legs 18 have been bent, as shown in FIG. 6C, results from the different angles of inclination of the clamping surfaces 34 and the inner sides of the clamping legs 18 in the area of the conical clamping section 26. The angle of inclination of the clamping surfaces 34 is between 1° and 5° smaller than the angle of the inner sides 31 in the area of the conical clamping section 26, preferably about 2° smaller. Accordingly, the conical clamping section 26 remains slightly open in the direction of the insertion opening 19 even after the initial bending step.

In a further step of the process for contacting the wire ends 16 of a stator coil 12, the two clamping jaws 33 of the crimping device are pressed further together, see FIG. 6D. In doing so, the inclined clamping surfaces 34 press essentially over the entire outer sides 32 onto the clamping legs 18 and cause plastic deformation of the two clamping legs 18 in the area of the lower wire end 16' located at the transition between the base section 24 and the conical clamping section 26. The internal deformation of the clamping legs 18 in their longitudinal direction can cause the inclined clamping surfaces 34 to no longer bear against the outer sides 32 of the clamping legs 18 in the area of the feed-in opening 19. The plastic deformation of the clamping legs 18 can be seen very clearly in FIG. 6D in the reduced distances between the clamping jaws 33 and the upper area of the connection element 7. The plastic deformation of the two clamping legs 18 in the area between the base section 24 and the conical clamping section 26 causes the opening of the wire receptacle 20 to narrow further, wherein the inner sides 31 of the clamping legs 18 in the area of the conical clamping section 26 tilt further inwards until they are essentially parallel to each other and also fix the upper wire end 16".

The plastic deformation of the two clamping legs 18 in the area between the base section 24 and the conical clamping section 26 enables a relatively uniform contact pressure of the two clamping legs 18 on the wire ends 16 of the stator coil 12 and thus secure fixation of the wire ends 16 in the wire receptacle 20 of a connection element 7 according to the invention. It is sufficient if the contact pressure of the two clamping legs 18 on the upper wire end 16'‘ is sufficient for its secure fixation, even if the contact pressure on the lower wire end 16’ may be significantly higher due to the plastic deformation in the adjacent area of the clamping legs 18. Furthermore, for the secure fixation of the wire ends 16 in the conical clamping section 26 of the wire receptacle 20, it is irrelevant whether the two wire ends 16 are positioned on top of each other at the base section 24 of the wire receptacle 20 or whether the upper wire end 16" is arranged in the wire receptacle 20 at a distance from the lower wire end 16' resting on the base section 24.

After fixing the wire ends 16 of the stator coil 12 by plastically deforming the two clamping legs 18 in the area of the transition between the base section 24 and the conical clamping section 26, wire sections protruding from the fixed wire ends 16, in particular a winding glasses, can be removed, which not only allows the winding process of the stator coil 12 to be completed, but also provides radial accessibility to the connection elements 7.

In a further step in the process for manufacturing an electric motor 1 according to the invention, the wire ends 16 of the stator coil 12 can be welded to the clamping legs 18 of the fork-shaped contact element 17. For this purpose, welding tongs, in particular cooled welding tongs, of a welding device (not shown) are placed on the connection elements 7 from the outside and the wire ends 16 are welded to the clamping legs 18. Welding the wire ends 16 to the fork-shaped contact element 17 establishes a secure electrical contact between the wire windings of the stator coil 12 and the connection element 7, wherein, in contrast to a pure plug connection of the wire ends 16, welding reliably enables a low-resistance electrical contact and a high current carrying capacity. By welding the wire ends 16, the insulation of the wire ends 16 only needs to be removed during the welding process, so that it is not necessary to remove or cut the electrical insulation at the wire ends 16 of the coil windings before or during the crimping process.

### REFERENCE SIGN LIST

1 electric motor

2 housing

3 housing body

4 bearing shield

5 connection feed-through

6 connection tab

7 connection elements

8 motor shaft

9 rotor

10 stator

11 screw

12 stator coil

13 connector ring

14 sub-segment

15 phase conductor track

16 wire ends

17 fork-shaped contact elements

18 clamping legs

19 insertion opening

20 wire receptacle

21 lead-in chamfer

22 insertion slot

23 base

24 base section

25 conical base area

26 conical clamping section

27 opening section

28 elastic connecting elements

29 webs

30 annular protrusions

31 inner sides

32 outer sides

33 clamping jaws

34 clamping surfaces

a_{B} distance of the lower wire end

a_{E} distance of the parallel inner sides

ax axial direction

rad radial direction

l_{B} length of the base area

l_{D} total length of the wire receptacle

l_{K} length of the conical clamping section

l_{Ö} length of the opening section

α clamping angle

β opening angle

1. A connection element for the wire ends of stator coils of an electric motor, in particular for a multiphase electric motor with several stator coils, wherein at least one stator coil comprises at least two wire windings and the connection element is a fork-shaped contact element with two clamping legs which together form a wire receptacle for the wire ends of the at least two coil windings and a separate insertion opening,
wherein the wire receptacle between the two clamping legs is essentially conical in shape, and the conical wire receptacle has a base section, a conical clamping section and an opening section comprise, wherein the conical clamping section widens from the base section in the direction of the insertion opening, extending in particular over at least 40%, preferably over at least 60% of the length of the wire receptacle, and forms an angle, in particular between 10° and 20°, preferably approximately 14°, between the inner sides of the two clamping legs, and wherein the adjoining opening section tapers in the direction of the insertion opening.

2. The connection element according to claim 1, wherein the length of the conically shaped wire receptacle in the longitudinal direction of the contact element between the base section and the opening section is between 1.2 and 2.0 times, preferably between 1.25 times and 1.5 times the sum of the diameters of the wire ends.

3. The connection element according to claim 1, wherein the base section between a curved base at the lower end of the wire receptacle and the conical clamping section, comprises a conical base area which forms an angle between 60° and 70°, preferably approximately 65°, between the inner sides of the two clamping legs.

4. The connection element according to claim 1, wherein the insertion opening between the two clamping legs of the fork-shaped contact element has insertion bevels at the free ends of the two clamping legs, wherein the insertion bevels comprise an angle of the lead-in chamfers relative to the longitudinal direction of the contact element in each case between 20° and 45°, preferably between 25° and 25°, in particular approximately 30°.

5. The connection element according to claim 4, wherein the insertion opening comprises an insertion slot which extends between the insertion bevels of the two clamping legs and the opening section of the conically shaped wire receptacle and is formed by two substantially parallel sections of the inner sides of the two clamping legs, wherein the distance between the substantially parallel sections of the inner sides of the two clamping legs is at least the diameter of the wire ends, preferably 1.05 times the diameter of the wire ends.

6. A connector ring for a multiphase electric motor with several stator coils, in particular with at least two stator coils per phase, wherein at least one stator coil comprises at least two wire windings, and with at least one phase conductor track, a connection tab for contacting a phase controller of the stator coils, and at least one connection element for the wire ends of stator coils according to claim 1.

7. The connector ring according to claim 6, wherein a plurality of phase conductor tracks are provided, wherein the phase conductor tracks are designed as circular ring sections and are arranged offset from one another in order to contact the stator coils of the multiphase electric motor arranged next to one another by means of the at least one connection element.

8. The connector ring according to claim 6, wherein each phase conductor track is manufactured as a stamped and bent component with the connection tab for contacting a phase controller and the at least one connection element for the wire ends of stator coils.

9. A multiphase electric motor with a rotor, a stator, and several stator coils, wherein at least one stator coil comprises at least two wire windings, and with a connector ring according to claim 6, wherein the wire ends of the at least two wire windings are crimped and welded in a connection element of the connector ring.

10. A method for contacting the wire ends of a stator with at least two coil windings by means of a connection element according to claim 1, comprising the steps:
inserting the at least two wire ends of the coil through the insertion opening into the substantially conical wire receptacle between the two clamping legs of the fork-shaped contact element, wherein one wire end is arranged at a base section of the conically shaped wire receptacle;
pressing together the two clamping legs by means of two inclined clamping jaws which bear against the outer sides of the two clamping legs;
bending the two clamping legs over the wire end arranged on the base section, whereby the opening of the substantially conical wire receptacle tapers and secures the other wire ends of the coil in the wire receptacle;
further compressing the two clamping legs by means of the two inclined clamping jaws;
plastic deformation of the two clamping legs in the area of the wire end arranged at the base section whereby the opening of the essentially conically shaped wire receptacle further tapers and the other wire ends of the coil are fixed in the wire receptacle.

11. The method for contacting the wire ends of a stator coil according to claim 10,
wherein the inclined clamping jaws are inclined both relative to the force vector when the clamping legs are pressed together and relative to the outer sides of the associated clamping legs, and the angle of inclination of the clamping jaws relative to the outer sides of the associated clamping legs is in particular between 3° and 7°, preferably approximately 5°, wherein the clamping jaws initially rest against the ends of the two clamping legs when the two clamping legs are pressed together.

12. The method for contacting the wire ends of a stator coil according to claim 11,
wherein the angle of inclination of the clamping jaws is smaller than the angle of the inner sides of the clamping legs in the area of the conical clamping section, in particular between 1° and 5° smaller, preferably approximately 2° smaller.

13. The method for contacting the wire ends of a stator coil according to claim 10, wherein, after plastic deformation of the two clamping legs for fixing the at least two wire ends of the stator coil between the two clamping legs in the clamping section of the wire receptacle, the following steps are performed:
removing protruding wire sections from the wire ends fixed in the wire receptacle, in particular removing a winding spacer;
providing a welding device;
applying the welding device to the connection element;
welding the wire ends of the at least two coil windings to the two clamping legs of the connection element.

14. The method for contacting the wire ends of a stator coil according to claim 13, wherein the welding device is designed as welding pliers, in particular as cooled welding pliers, the welding pliers are pressed against the two clamping legs of the connection element and the wire ends of the stator coil fixed between the two clamping legs are welded to the two clamping legs in order to enable reliable electrical contacting between the wire ends of the at least two wire coil windings and the connection element.
